(19) United States
(12) Patent Application Publication
(10) Pub. No.: US 2013/0185191 A1
(43) Pub. Date: Jul. 18, 2013

(54) SYSTEMS AND METHOD FOR CORRELATING TRANSACTION EVENTS

(71) Applicant: Shlomo COHEN GANOR, Beit Zayit (IL)

(72) Inventor: Shlomo COHEN GANOR, Beit Zayit (IL)

(21) Appl. No.: 13/349,648

(22) Filed: Jan. 13, 2012

(51) Int. Cl. G06Q 40/00

(52) U.S. Cl. 705/39

(57) ABSTRACT

A method and system for correlating transaction events. Transaction events may be received that identify actions executed at a plurality of different types of source systems. For each transaction event, it may be determined whether or not the transaction event is equivalent to a previous transaction event using an equivalence relationship. The equivalence relationship may define events as being equivalent when each of the events has a subset of parameters that match exactly and a different subset of parameters that match approximately and not exactly. Equivalent transaction events may be correlated.

### FIELD OF THE INVENTION

Embodiments of the invention relate to correlating transaction events over a transaction lifecycle. The correlated events may be analyzed together, for example, for fraud detection.

### BACKGROUND OF THE INVENTION

Banks and other monetary institutions typically handle such a great number of transactions every day that they need automated systems to analyze the transactions, for example, to detect fraud. Current automated fraud detection mechanism typically input a transaction event, such as, a purchase, wire transfer or deposit, into a fraud detection mechanism that checks the transaction event for possible fraudulent activities. The fraud detection mechanism may scan the transaction event for predetermined criteria associated with possibly fraudulent or suspicious activities, for example, large monetary transactions, transactions at a foreign or atypical location inconsistent with the customer's profile, past payment changes to the recipient, etc.

However, each separate transaction event, analyzed alone, may only provide partial information necessary to detect fraud. In one example, a customer may be enrolled in a recurring credit card payment program making monthly payments to an authorized recipient. In one scenario, a fraudster may interrupt the payments by re-routing the payments to his/her personal account. Analyzed alone, the fraudulent transaction event may appear normal. The fraud detector may fail to recognize that the new payment is inconsistent with the previous pattern of recurring payments. Accordingly, such fraud may go undetected.

### SUMMARY OF THE INVENTION

Some embodiments of the invention may correlate transaction events. Transaction events may be received that identify actions executed at a plurality of different types of source systems. For each transaction event, it may be determined whether or not the transaction event is equivalent to a previous transaction event using for example an equivalence relationship. The equivalence relationship may define events as being equivalent when each of the events has a subset of parameters that match exactly and a different subset of parameters that match approximately and not exactly. Equivalent transaction events may be correlated.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system including a correlation engine for correlating transaction events in accordance with an embodiment of the invention; and

FIGS. 2A and 2B are flowcharts of a method for correlating transaction events in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention describe systems and methods for correlating, grouping or associating individual transactions events together to form complete transactions. When described herein, events that are correlated may mean events that are matched, grouped, associated or linked together, for example in a processing system, for example based on rules, equivalence relations, functions, and/or correlation configuration sets. Correlating events may include comparing events, determining or deeming certain events as equivalent, and grouping the events, for example into a transaction.

A transaction may include a sequence of one or more related or correlated events that occur over time. For example, a recurring credit card payment is a transaction that includes transaction events, such as, monthly payments, account updates, annual rate adjustments, tax payments, etc., all related to the same payment transaction. Since new events occur over time, transactions may be dynamic data sets that continually change, for example, each time a new related event is made. It may be appreciated that although transactions are described herein to relate to monetary transactions, embodiments of the invention may relate to transactions of any other (non-monetary) type, such as, medical or insurance events (e.g., appointments, claims, etc.), real estate transactions, data transactions (e.g., data transfers), trades or barters of goods or services, interactions with social media such as Facebook, account or customer profile creation or updates, etc.

In multi-platform systems, transaction events may be received from multiple different types of devices (e.g., salesman computers, website servers for online transactions, automated teller machines (ATMs), telephones for call center transaction, etc.) using multiple different event data types (e.g., formats, data representations, protocols, computer/telephone languages, computing platforms, etc.). To process such a wide variety of data types from such a wide variety of source devices, some multi-platform systems may transform all the event data into a standardized or uniform data type or platform and then correlate the data using a single standardized set of rules or correlation configuration set. Alternatively or additionally, different rules or correlation configuration sets may be used to correlate event data of each different data type and/or source device.

To correlate transaction events, embodiments of the invention may compare event parameters, data fields or identifiers associated with each transaction event, such as, a customer or client identity, an account number/ code or identity, a monetary amount, a transaction recipient, and/or a set-up date and time in which the payment is created. The correlation engine may correlate transaction events associated with the same sets of transaction parameters, for example, as defined by an equivalence relationship associated with the selected correlation configuration set. In addition to correlating events having exactly matching (the exact same) transaction parameters, the equivalence relationship may also define correlations for events having almost, though not exactly, matching (similar) transaction parameters.

Correlating events each having “close” or “similar” parameters may be referred to as “fuzzy” or approximate correlation since the correlation includes non-exact matching. Whereas an exact correlation generates a transaction with only events with parameters that exactly match, fuzzy correlation generates a transaction that is “larger” or inclusive of both exact and non-exact matching events. In some cases, parameters for events may vary within a transaction, for example, due to annual rate adjustments, opening/closing accounts, differences in amounts purchased on a credit-card account, time of transaction, payment amount rounded up or down, etc. By including fuzzy or non-exact variations of transaction events, the correlated transaction events may more accurately reflect the complete transaction.

In one example, a payment amount for a recurring credit card payment transaction (e.g., a payment by credit card to a mortgage company, publisher, utility, etc.) may change. An exact correlation mechanism may identify different amount parameters for each monthly payment and therefore separate these payments into different transactions when in fact they are part of the same recurring transaction. The cause of such a payment change may be authorized (e.g., due to a price increase or expiration of an introductory rate) or fraudulent (e.g., adjusted without the customer's consent). However, regardless of the cause, a fuzzy correlation may correlate or link these events with different amount parameters to the same transaction. Once linked, the change in the payment amount of the events may alert a fraud detection mechanism, for example, to place that transaction on hold until authorized, to lock an account, or to send an alert to a customer or agent.

Fuzzy correlations may be semi-exact and semi-fuzzy, for example, correlating events that have exact matches for a subset of parameters while allowing non-exact or fuzzy matches for a different subset of parameters. In one embodiment, for each transaction event, the correlation engine may determine whether or not the transaction event is equivalent to a previous transaction event using an equivalence relationship. If a transaction event is determined to be equivalent, it is correlated; if a transaction event is determined to not be equivalent, it is not correlated. The equivalence relationship may define events as being equivalent when each of the events has a subset of parameters that match exactly (exact correlation) and a different subset of parameters that match approximately and not exactly (fuzzy correlation). For example, customer parameters may exactly match since typically customers do not change within a transaction. However, transaction amount parameters may approximately match since rates may change over time, amounts may be rounded up or down, etc. The set-up date and time parameter may also be an approximate (or exact) match criterion since updates may be made to an account over time, times may be rounded up or down, etc. The account identifier is typically an exact match criterion, but may be a fuzzy match criterion in some instances, such as, when a payment transaction is redirected to a different account associated with the same customer. In general, the equivalence relation may correlate any parameter using an exact or fuzzy match criterion, thereby defining correlated events based on exact or approximate matching parameters, respectively. For example, a subset of (N) parameters may match exactly and a subset of (M) parameters may match approximately, where (N) and (M) may be any natural number, e.g., 1, 2, 3, . . . (greater than zero or including zero).

Fuzzy correlations may have a predetermined range by which parameters may differ for them to still be considered part of the same transaction. This “degree” or “fuzziness” of fuzzy correlations may be defined in the equivalence relationship by setting a range or conditions to limit which values or states of the fuzzy parameters are correlated. In one example, the equivalence relationship may define a correlation between events within a first amount range and a new transaction for events outside of that range.

In general, a correlation engine may correlate events (such as transaction events) defined to be “equivalent” based on an equivalence relation. The equivalence relation may include any suitable function or definition of equivalence, both exact and “fuzzy.” For example, two events may be equivalent, for example, if their equivalence function defines the same or similar values for any combination of event parameters (e.g., using an identity value function) or if their compared function value or score is within a predetermined range or result (e.g., using an identity equality function). The equivalence relation may input two events and output an equivalence score therefore or value or determination of equivalence, non-equivalence or indeterminate equivalence. In some embodiments, the equivalence relations and functions may be flexibly programmed and changed over time. Furthermore, an event override operation, e.g., executed by an authorized agent or user, may override the correlation engine decision and change correlated events to not correlated events or vice versa.

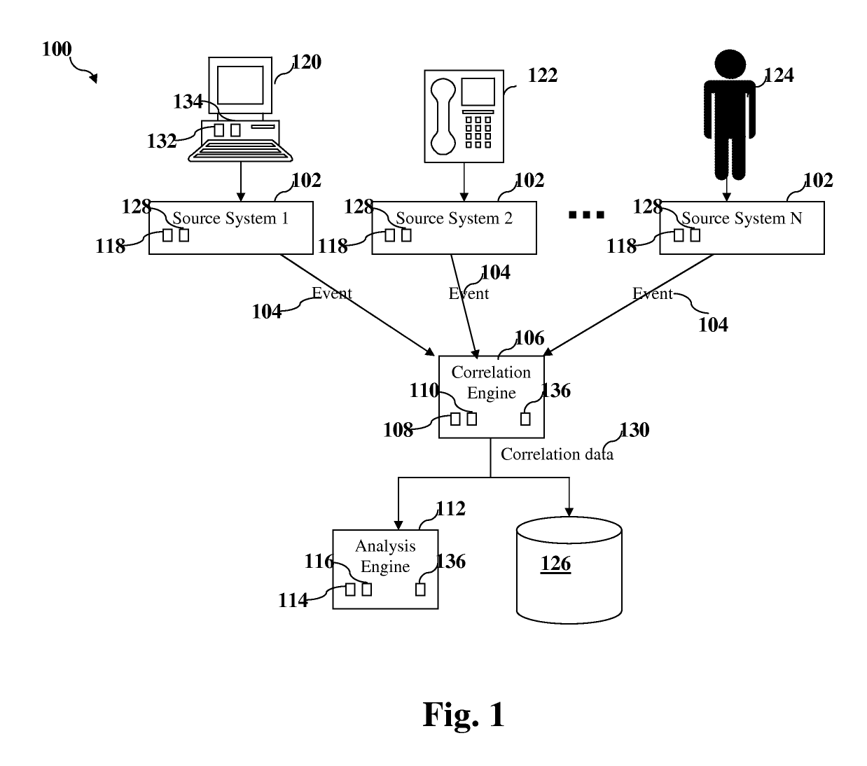

Reference is made to FIG. 1, which schematically illustrates a system 100 including a correlation engine 106 for correlating transaction events 104 in accordance with an embodiment of the invention.

Correlation engine 106 may receive and analyze transaction events 104 from a plurality of (N) different source systems 102 (source system 1-N). Correlation engine 106 may analyze transaction events 104 for any purpose, such as, fraud detection, financial analysis, customer-targeted marketing, insurance adjustments, etc.

Source systems 102 may include any device or system capable of handling or recording transaction events 104 and sending notification of such events 104 to correlation engine 106. Source systems 102 may include, for example, banking or transaction processing systems or servers, point-of-sale (POS) devices, ATMs, payment or check point devices, salesman or agent computers, customer computers, secure payments systems, mobile scanners or terminals, etc., and/or any combination thereof.

A user operating a user device, such as a computer 120 or a telephone 122, may initiate or authorize transaction events 104. The user device may be compatible with the type of source systems 102. For example, a user may use computer 120 for online transaction events 104 executed by a system server and telephone 122 for events 104 executed by an agent at a computer. Alternatively or additionally, a user 124 may interact directly with source system 102 (without operating an intermediate device), for example, using source system 102 devices such as an ATM, POS device, etc.

Source systems 102, correlation engine 106, analysis engine 112 and user computer 120 (or other user device), may each include one or more controller(s) or processor(s) 118, 108, 114 and 132, respectively, for executing operations and one or more memory unit(s) 128, 110, 116 and 134, respectively, for storing data and/or instructions (e.g., software) executable by a processor. Processor(s) 118, 108, 114 and 132 may include, for example, a central processing unit (CPU), a digital signal processor (DSP), a microprocessor, a controller, a chip, a microchip, an integrated circuit (IC), or any other suitable multi-purpose or specific processor or controller. Memory unit(s) 128, 110, 116 and 134 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units. In one embodiment, correlation engine 106 and analysis engine 112 may be part of the same device and thus processor(s) 108 and 114 may be the same and/or memory unit(s) 110 and 116 may be the same. In some embodiments, correlation engine 106, analysis engine 112, a fraud detector 136, and other units may be, or have their functionality be performed by, one or more processor such as processor(s) 108 and/or 114 executing instructions or software.

Transaction events 104 may include an action associated with a transaction or notification of such action. For example, transaction events 104 may include notification that a new transaction is set up, a previously set up transaction is updated, a previously set up transaction is cancelled, a transaction is approved or denied, a transaction is cancelled, a transaction is executed, etc.

Correlation engine 106 may correlate individual events 104 with a transaction, which includes one or more related events. A transaction may include, for example, a loan, a wire transfer, an automated clearing house (ACH) transfer, a recurring bill payment, a cash withdrawal, a check deposit, checkbook order, payee setup, electronic authentication or other transaction. Correlation engine 106 may use a set of criteria to determine if a new event 104 is correlated to previous events 104 in any previously created transactions. If so, the event may be correlated with or associated with that transaction and its events by assigning the corresponding transaction identification (ID). If not, a new transaction and corresponding transaction ID may be created and assigned to the event, which may be the first event of the new transaction. Correlation engine 106 may correlate transactions in real-time, e.g., as they are received, or in a post-processing stage all together.

The criteria for correlating transaction events 104 may be defined by an equivalence relation, for example, defined in a correlation configuration set associated with each source systems 102 or data type of the event 104. Correlation engine 106 may use the equivalence relation to evaluate transaction events 104 and determine if their parameters or subsets of their parameters exactly match (for exact correlations) or approximately match (for fuzzy correlations). The equivalence relation and the criteria therein may be predetermined by a programmer or set and changed by a user. For example, the equivalence relation may correlate events 104 that have the exact same customer parameter values (defining the same customer entity, e.g., by name or customer ID), the exact same account parameter values (defining the same user/recipient account, e.g., by account number), but only a similar amount parameter and/or set-up date/time parameter (defining a similar amount and/or a similar time window for the transaction event). Other parameters, criteria and/or equivalence relations may be used to correlate events 104.

Once events 104 are associated, grouped, correlated or bundled into transactions, correlation engine 106 may output correlation data 130. Correlation data 130 may include a list, table or summary of the correlation between transaction events 104 over the transaction lifecycle. Correlation data 130 may list the certainty or reliability of the correlations, for example, using the equivalence relation functions, scores or by ranking or ordering the events in order of their correlation certainty. Correlation data 130 may have marked any uncertain correlations for a user or administrator to resolve. Correlation data 130 may be used to detect if fraud has taken place by analyzing a pattern of the correlated transaction events 104 over a lifecycle of the transaction. Fraud detection may be executed at correlation engine 106, analysis engine 112 or at a designated fraud detector 136. Correlation data 130 may trigger a flag or an alert to be sent when any suspicious or possibly fraudulent data is detected. Correlation data 130 may be stored locally in a memory unit 110 of correlation engine 106 or transferred remotely to database 126 and/or a memory unit 110 in an analysis engine 112. Correlation data 130 may be analyzed or processed locally by a processor 108 internal to correlation engine 106, by fraud detector 136, or remotely by a processor 114 internal to analysis engine 112. Analysis engine 112 may analyze correlation data 130 according to any set of rules or for any suitable purpose. Analysis engine 112 may be part of system 100 or another system, for example, subscribing via an account to correlation engine 106 or system 100. Analysis engine 112 may include a plug-in, application, website, logic tables and/or other interface(s) to recognize and use correlation data 130.

Correlation data 130 may be used to analyze events 104 in the context of the entire transactions lifecycle of which the event is a part. Analyzing the entire lifecycle of the transaction may provide patterns, information on similar events executed via other communication channels or device pathways, information on the way in which the transaction's events change over time, or other insights not otherwise available via only the single most recent event 104 alone or exactly matching events. Events may be analyzed for any application, such as, fraud detection, marketing analysis, data security, etc. Events may be analyzed by, for example, one of processors 108 or 114, or other processors.

In one embodiment, correlation engine 106 may include a software or hardware module that recognizes and uses, for example, the following data structures and data types to associate, equate, group, or correlate events 104 (other data structures and types may also be used):
Transaction events 104—an event or event notification sent from a source system 102 to correlation engine 106 to indicate that an event has occurred for or on a transaction.
Identity value function—a function that generates a value or string representing each transaction events 104 (e.g., and their parameter values) so that the events may be compared for equivalence based on these values. The identity value function may use the following interface:
   Input—an event 104.
   Output—a scalar value such as a string or number.
Identity equality function—a function that generates a value or true/false defining the similarity or equivalence between two transaction events 104 (e.g., based on their parameter values). The identity equality function may use the following interface:
   Input—set of exactly two events.
   Output—true/false.
Equivalence Relation—an equivalence score or value or true/false determination defining whether or not transaction events 104 are equivalent (or that the equivalence cannot be determined with the current information). The equivalence relation may include the following:
   Equivalence Relation ID—a number or string.
   Identity value function.
   Identity equality function.
Correlation configuration set—a set of equivalence relationships, each of which may be used for different input data types or source systems 102 or for different rules of equivalence. The correlation configuration set may include the following:
   Correlation configuration set ID—a number or string.
   Set of equivalence relations (one or more).
Event Identity Key—a data structure used to represent transaction events 104 in an efficient manner stored in a map data structure. The event identity key may include the following:
   Identity value—a value of the same type as the output of the identity value function.
   Correlation configuration set ID.
   Equivalence relation ID.
Events map—a data structure that stores key-value pairs and may be optimized to perform efficient insert and look-up operations given a single input key.
   Key—an event identity key.
   Value—an event.
Correlation Engine—a software process or set of processes used to correlate transaction events 104, for example, storing at least the following data:
   Set of correlation configuration sets (one or more).
   Events map.

Within correlation engine 106, one or more correlation configuration sets may be defined. A correlation configuration set may define a specific correlation behavior to be used for a specific subset of events 104 that are processed by correlation engine 106. For example, a single correlation configuration set may be defined for all events 104 that are processed by correlation engine 106, or separate correlation configuration sets may be defined for events relating to different transaction types or source systems 102. When separate correlation configuration sets are used, correlation engine 106 may select the appropriate single correlation configuration set to use for each event 104. In one embodiment, a configuration set may define an equivalence relation where two events relating to the same transaction (e.g., transaction events) are equivalent and/or a different equivalence relation where two events relating to the same prior event are equivalent.

A correlation configuration set may define one or more equivalence relations on events, each defined via the following settings:
Identity value function—application logic executable by correlation engine 106 in which an event 104 is the input and the output may be a value (e.g., a string or a number) such that two events that are equivalent with respect to the specific equivalence relation always produce identical values.
Identity equality function—application logic executable by correlation engine 106 in which two events are the input and the output may be a true/false indication such that two events that are equivalent with respect to the equivalence relation always produce a true indication.

Both the identity value function and the identity equality function may use the equivalence relation to determine whether or not events match. The equality function may define a fuzzy match such that events with approximate parameters match. The identity value function may allow for a broad range or fuzzy criteria to define a match. For example, the identity value function may input an event's timestamp, round it down to the nearest half hour, and use the result as (part of) the identity value. This example function defines simple fuzzy matching logic, in which two events may match if their timestamps differ by up to half an hour.

The identity equality function may allow for an even broader definition of matching events. For example, identity equality function inputs a pair of events and uses any logic to determine whether or not they match. As an example, a similarity score that may be calculated by combining multiple parameter values, for example, the difference in time between the events, the difference in payment amount between the events, whether the events arrived from the same source system 102, etc. The identity equality function may define a match between events that have a similarity score within a predetermined range, for example, above a predetermined threshold value. In some embodiments, the identity equality function may be more flexible than the identity value function. However, the identity value function may be more efficient than the identity equality function and may be used to boost system 100 performance.

For a given equivalence relation and a given pair of events 104, correlation engine 106 may determine whether the events are equivalent by checking if all (or some) of the following conditions are satisfied:
Both events 104 use the same correlation configuration set.
The corresponding identity value function produces the same value for both events.
The corresponding identity equality function produces a true value for the pair of events.

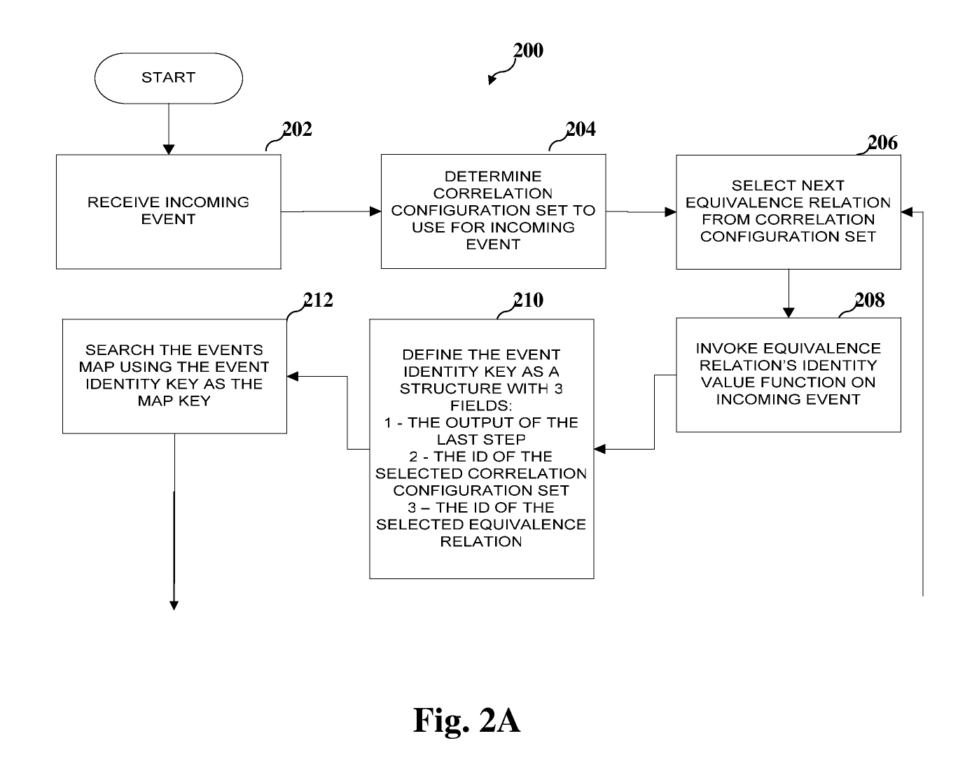

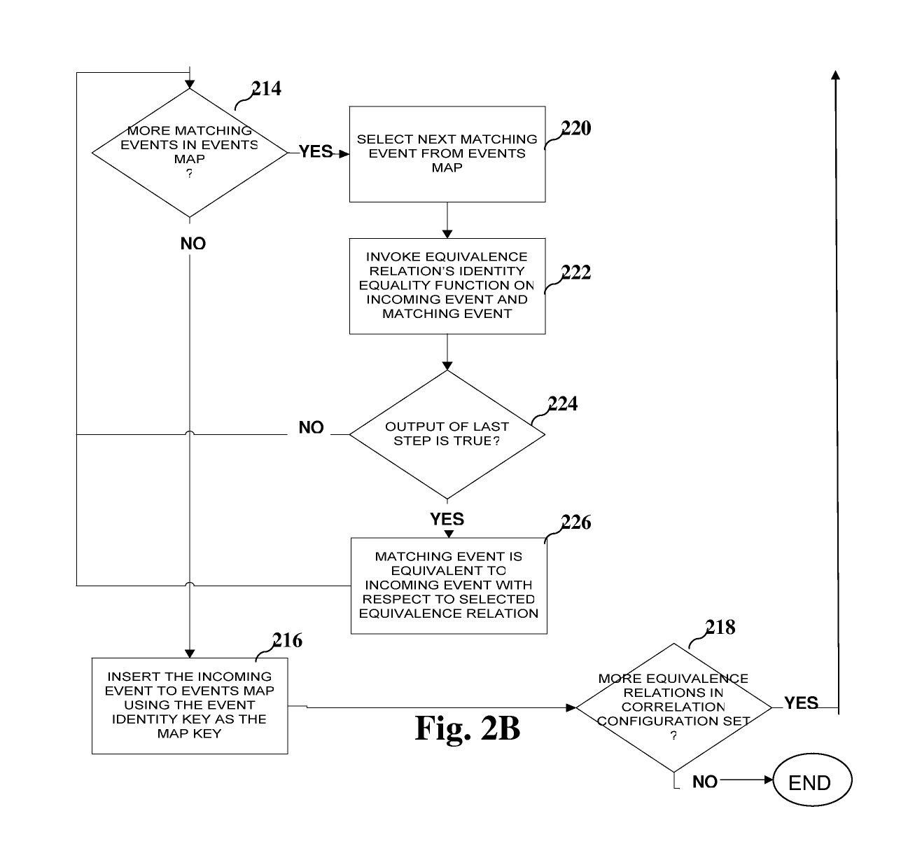

Reference is made to FIGS. 2A and 2B, which are flowcharts of a method 200 for correlating transaction events in accordance with an embodiment of the invention. A correlation engine or another unit or units may execute the steps of method 200 to determine event equivalence between any two events (these steps may be repeated to determine equivalence for any additional number of events). It may be appreciated that FIGS. 2A and 2B, form one flowchart of a method 200 for correlating transaction events, divided across two figures due to space constraints.

In operation 202, a correlation engine (e.g., correlation engine 106 operating processor 108 of FIG. 1) may receive one or more incoming transaction events (e.g., transaction events 104 of FIG. 1) from source devices (e.g., source system 102 of FIG. 1).

In operation 204, the correlation engine may determine the correlation configuration set to use for each incoming event, for example, based on the source device, received data type and/or a desired type of correlated output data (e.g., correlation data 130 of FIG. 1).

In operation 206, the correlation engine may select an equivalence relation from the correlation configuration set for each incoming event (or a next equivalence relation if operation 218 determines the correlation configuration set includes additional relations not yet tested in previously iteration(s)). The equivalence relations may define events as being equivalent when each of the events has a subset of parameters that match exactly (an exact criteria for correlating events) and a different subset of parameters that match approximately and not exactly (a fuzzy criteria for correlating events).

In operation 208, the correlation engine may execute an identity value function associated with the selected equivalence relation on each incoming event.

In operation 210, the correlation engine may define an identity key for the incoming event, for example, as the combination of:
the output value produced by the equivalence function in operation 208;
a unique identifier for the correlation configuration set; and/or
a unique identifier for the equivalence relation.

The correlation engine may store the incoming event in a memory unit (e.g., database 126 or memory unit 110). The incoming event may be stored in a map data structure, such as, a hash table or a B-tree, for example, using the identity key defined in operation 210 as the key and the event parameters as the value. Alternately, a subset of the event parameters may be stored. As a concrete implementation choice, a relational database table may be used to store each incoming event, with the identity key defined in operation 210 used as a (e.g., non-unique) index.

In operation 212, the correlation engine may search an events map for other events indexed with identity keys that match the identity key defined in operation 210 for the incoming event. After operation 212, a process or processor may proceed to operation 214.

In operation 214, the correlation engine may determine if there are any matching events in the events map (or additional matching events if operation 214 has previously been yes in a previous iteration). If are no such matching events in the events map, a process or processor may proceed to operation 216; otherwise, a process or processor may proceed to operation 220.

In operation 216, the correlation engine may insert the incoming event into the events map using the event identity key defined in operation 210 as the map key.

In operation 218, the correlation engine may determine if there are more equivalence relations in the correlation configuration set. If there are additional equivalence relations, a process or processor may return to operation 206 to select the next equivalence relation from the correlation configuration set; otherwise, a process or processor may end.

In operation 220, the correlation engine may select the next matching events in the events map.

In operation 222, the correlation engine may execute the equivalence relation's identity equality function on the matching event selected in operation 220. The equivalence relations may define events as being equivalent when each of the events has a subset of parameters that match exactly (an exact criteria for correlating events) and a different subset of parameters that match approximately and not exactly (a fuzzy criteria for correlating events).

In operation 224, the correlation engine may determine if the identity equality function of the equivalence relation is true. If the identity equality function is false, the incoming event and matching event are not correlated and a process or processor may return to operation 214 to test another event. However, if the identity equality function is true, a process or processor may proceed to operation 226.

In operation 226, the correlation engine may determine that the incoming event is equivalent to the matching event selected in operation 220 and the events may be correlated, for example, associated with the same transaction ID. After the events are correlated, a process or processor may return to operation 214 to test another event (if one exists).

Other operations or orders of operations may be used.

To demonstrate an example of method 200, a system may include two types of events, for example, online wire transfers and cash withdrawals. Event data may include, for example, the following parameter fields:
For online wire transfers, parameter fields may include: event ID, event date/time, event type, transaction number, and customer number.
For cash withdrawals, parameter fields may include: event ID, event date/time, event type, and customer number.

Each of the event types (e.g., online wire transfers and cash withdrawals) has a corresponding correlation configuration set. The correlation configuration set for online wire transfers may define, for example, the following equivalence relations:
Transaction identity—
   Identity value function—returns the transaction number as output.
   Identity equality function—returns true if the identity values of the given input events are identical; false otherwise.
Customer Identity—
   Identity value function—returns the customer number as output.
   Identity equality function—returns true if the identity values of the given input events are identical; false otherwise.
      The correlation configuration set for cash withdrawals may define, for example, the following equivalence relation:
Customer Identity—
   Identity value function—returns the customer number as output.
   Identity equality function—returns true if the identity values of the given input events are identical; false otherwise.

Table 1 describes a sequence of consecutive events (e.g., with event IDs 1-5) processed by the correlation engine.

TABLE 1
Summary of Transaction Events

| Event | | | Transaction | Customer |
|---|---|---|---|---|
| ID | Event date/time | Event Type | Number | Number |
| 1 | 12/7/2009 15:30 | Online Wire | 1 | 1 |
| 2 | 12/7/2009 15:31 | Cash Withdrawal | | 1 |
| 3 | 12/7/2009 15:32 | Online Wire | 1 | 2 |
| 4 | 12/7/2009 15:33 | Cash Withdrawal | | 2 |
| 5 | 12/7/2009 15:34 | Online Wire | 2 | 2 |

In the example of table 1, events 1, 3 and 5 use the online wire correlation configuration set, and events 2 and 4 use the cash withdrawal correlation configuration set. The transaction events of table 1 may define event identity keys, for example, as shown in table 2.

TABLE 2
Summary of Identity Keys Defining for the Transaction Events of Table 1

Identity Key

| | Correlation | Equivalence | Identity |
|---|---|---|---|
| Event ID | Configuration Set | Relation | Value |
| 1 | Online Wire | Transaction | 1 |
| 1 | Online Wire | Customer | 1 |
| 2 | Cash Withdrawal | Customer | 1 |
| 3 | Online Wire | Transaction | 1 |
| 3 | Online Wire | Customer | 2 |
| 4 | Cash Withdrawal | Customer | 2 |
| 5 | Online Wire | Transaction | 2 |
| 5 | Online Wire | Customer | 2 |

Storing the information in table 2 in a map data structure grouped by the identity keys may allow the correlation engine to easily sort groups of potentially equivalent or correlated events, for example, as shown in table 3.

TABLE 3
Summary of Correlated Groups of the Transaction Events of Table 1

| Identity Key | | | |
|---|---|---|---|
| Correlation | Equivalence | Identity | |
| Configuration Set | Relation | Value | Event IDs |
| Cash Withdrawal | Customer | 1 | 2 |
| Cash Withdrawal | Customer | 2 | 4 |
| Online Wire | Customer | 1 | 1 |
| Online Wire | Customer | 2 | 3, 5 |
| Online Wire | Transaction | 1 | 1, 3 |
| Online Wire | Transaction | 2 | 5 |

In the example of table 3, events 3 and 5 are correlated with respect to the online wire transfer customer equivalence relation because they have identical identity keys, and events 1 and 3 are correlated with respect to the online wire transfer transaction equivalence relation for the same reason.

In an example scenario, a correlation engine (e.g., correlation engine 106 of FIG. 1) may use event equivalence to identify and correlate repeat events in which source systems (e.g., the same source systems 102 of FIG. 1) repeatedly send the correlation engine the same type of event (e.g., the exact same data except for the event's time/date and ID). In one example, the event may be re-sent due to for example a suspected technical issue while processing the original event. For example, a source system that sends an event to a correlation engine and does not receive a response from the correlation engine within a predefined time period (e.g., the request “times-out”) may be configured to resend the same event again to the same correlation engine, and repeat this up to a predetermined number (e.g., three) times, until a successful response is returned from the correlation engine. A non-repeat event may include an event of a type that is sent to the correlation engine for the first time (e.g., unique data excluding the event's time/date and ID). The correlation engine may operate, for example, as follows:
1. Identify a subset of event data fields or parameters that may exactly match among equivalent events. This may, for example, exclude parameters that are recalculated every time an event is sent to the correlation engine. The recalculated parameters may be defined by a fuzzy (non-exact) match.
2. Use an equivalence relation function, such as, an identity value function in which two events are equivalent if they have identical function values in all of the data fields identified in the previous step.
3. For each incoming event that is potentially a repeating event, find all previously processed non-repeat events that are equivalent to the current event. Repeat events may be different events that share all data except for timing, ID and any other unique identifiers or data that is automatically set and cannot be controlled by a user.
4. If there are no such previous events, the current event may be determined to be a non-repeat event, and is processed accordingly.
5. If there is exactly one such previous event, the current event may be determined to be a repeat event of the previous event and is processed accordingly.
6. If there is more than one such previous event, it may be indeterminate whether or not the current event is a repeat event. In such a case, there may be at least two previous events that have identical function values in the subset of parameters and were not identified as potentially repeating, hence the subset of exactly matching parameters may be insufficient to uniquely establish event identity, and may be difficult to determine based on these fields whether or not the current event is a repeat event.

In one example of the above scenario, the source systems may be referred to as “A” and “B.” Each source system A and B may send events that are potentially repeating events. The correlation engine may correlate repeat events with corresponding non-repeat events. Each source system may have a transaction counter that is reset (e.g., periodically, such as, daily) to a normalized value (e.g., one (1)) and may be used to assign consecutive numbers to new transactions.

The correlation engine may include a single correlation configuration set with a single equivalence relation, for example, defined as follows:
Identity value function—concatenates the event type, source system, transaction date and transaction number into a single string, and returns the string as output.
Identity equality function—returns true if the identity values of the given input events are identical; false otherwise.

A sequence of consecutive events processed by the correlation engine may be described, for example, as shown in Table 4:

TABLE 4
Summary of Input Data for Transaction Events

| Event | | Event | Source | Transaction | Transaction |
|---|---|---|---|---|---|
| ID | Event Date/Time | Type | System | Date | Number |
| 1 | 12/7/2009 15:30 | Setup | A | 12/7/2009 | 1 |
| 2 | 12/7/2009 15:31 | Setup | A | 12/7/2009 | 2 |
| 3 | 12/7/2009 15:32 | Setup | B | 12/7/2009 | 1 |
| 4 | 12/7/2009 15:33 | Setup | A | 12/7/2009 | 2 |
| 5 | 12/7/2009 15:34 | Setup | A | 12/7/2009 | 2 |
| 6 | 12/7/2009 15:35 | Update | A | 12/7/2009 | 2 |

The correlation engine may apply the identity value function to the input data for these events, which may yield identical outputs for events with IDs, for example, in the following groups:
Event ID 1
Event IDs 2, 4, 5
Event ID 3
Event ID 6

The correlation engine may correlate each of the events of Table 4, as it arrives, with a previous event, for example, as shown in Table 5:

TABLE 5
Summary of Repeat Transaction Events in Table 4

| | Previous equivalent | |
|---|---|---|
| Event ID | events | Processed as |
| 1 | none | Non--repeat |
| 2 | none | Non-repeat |
| 3 | none | Non-repeat |
| 4 | 2 | Repeat of 2 |
| 5 | 2 | Repeat of 2 |
| 6 | none | Non-repeat |

It may be noted that event 5 is not identified as a previous equivalent event of event 4 because event 4 is not a non-repeat event (e.g., it is itself a repeat event).

In another example scenario, the correlation engine may use event equivalence to identify and correlate events that update other transaction events, for example, events where significant details of a transaction are changed. The correlation engine may operate, for example, as follows:
1. Identify a subset of event data fields or parameters that may exactly match between transaction update events that relate to the same transaction. For example, such exactly matching parameters may include a transaction key generated by the source system to identify the transaction, a party key identifying the party that set up the original transaction, a date parameter defining the date when the transaction was originally set up and/or other details.
2. Use an equivalence relation function, such as, an identity value function in which two events are equivalent if they have identical function values in all of the data fields identified in the previous step.
3. For each incoming event that is potentially a transaction update event, find all previously processed events that are transaction setups or transaction updates and have an equivalent identity function value as the current event.
4. If there are no such previous events, the current event may be determined to be a non-transaction update event and is processed accordingly.
5. If there are one or more such previous events, select the most recent one of such events. The current event may be determined to be a transaction update event with reference to the selected previous event.

In one example of the above scenario, the source systems may be referred to as “A” and “B.” Each source system A and B may send events that are both setup and update events. The correlation engine may correlate the update events with the corresponding setup events. Each source system may have a transaction counter that is reset (e.g., periodically, such as, daily) to a normalized value (e.g., one (1)) and may be used to assign consecutive numbers to new transactions.

The correlation engine may include a single correlation configuration set with a single equivalence relation, for example, defined as follows (other definitions or characteristics may be used):
Identity value function—concatenates the source system, transaction date and transaction number into a single string, and returns the string as output.
Identity equality function—returns true if the identity values of the given input events are identical; false otherwise.

A sequence of consecutive events processed by the correlation engine may be described, for example, as shown in Table 6:

TABLE 6
Summary of Input Data for Transaction Events

| Event | | Event | Source | Transaction | Transaction |
|---|---|---|---|---|---|
| ID | Event date/time | Type | System | Date | Number |
| 1 | 12/7/2009 15:30 | Setup | A | 12/7/2009 | 1 |
| 2 | 12/7/2009 15:31 | Setup | A | 12/7/2009 | 2 |
| 3 | 12/7/2009 15:32 | Setup | B | 12/7/2009 | 1 |
| 4 | 12/7/2009 15:33 | Setup | B | 12/7/2009 | 2 |
| 5 | 12/7/2009 15:34 | Setup | A | 12/7/2009 | 3 |
| 6 | 12/8/2009 12:30 | Update | A | 12/7/2009 | 2 |
| 7 | 12/8/2009 12:31 | Update | A | 12/7/2009 | 1 |
| 8 | 12/8/2009 12:32 | Update | B | 12/7/2009 | 2 |
| 9 | 12/8/2009 12:33 | Update | B | 12/7/2009 | 2 |

The correlation engine may apply the identity value function to the input data for these events, which may yield identical outputs for events with IDs, for example, in the following groups:
Event IDs 1, 7
Event IDs 2, 6
Event ID 3
Event IDs 4, 8, 9
Event ID 5

The correlation engine may correlate each of the events of Table 6, as it arrives, with a previous event, for example, as shown in Table 7:

TABLE 7
Summary of Update Transaction Events from Table 6

| Event ID | Previous equivalent events | Processed as |
|---|---|---|
| 1 | none | non update |
| 2 | none | non update |
| 3 | none | non update |
| 4 | none | non update |
| 5 | none | non update |
| 6 | 2 | update of 2 |
| 7 | 1 | update of 1 |
| 8 | 4 | update of 4 |
| 9 | 4, 8 | update of 8 |

Other equivalence relationships, identity value functions, identity equality functions, parameters and event input details may be used.

It may be appreciated that a transaction, which is adapted to include multiple events, may in some cases include one event, for example, when that event is the first of many or when no other related events are ever executed. In the trivial case of a single-event transaction, the transaction and the transaction event may be the same. However, generally when discussed herein, the non-trivial case is described in which a transaction may include (or is adapted to eventually include) multiple events. In one embodiment, when a transaction is opened, the transaction may include a “transaction opened” event or when a transaction is closed, the transaction may include a “transaction closed” event so that all transactions include multiple transaction events.

A transaction event may include a digital action or operation executed at a source system, for example, to modify an account, profile, or other user data or resources, such as, transferring money or information, updating an account profile, authorizing such transfers or updates, etc. Transaction events often relate to monetary transfers or other actions, but need not.

It may be appreciated that although certain devices and functionality are assigned to “users,” “customers,” “administrators,” “authorizers” and “agents” in a multi-platform transaction environment, such functionality may be implemented by any users in any environment. Users may include live users or automated user(s).

It may be appreciated that embodiments of the invention that described correlating transaction events in “real-time” may refer to correlating (or initiating a sub-process adapted uniquely for correlating) instantly, at a small time delay of, for example, between 0.01 and 10 seconds, during the transaction event or session, concurrently, or substantially at the same time as.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method, implemented using one or more processors and associated memories, for correlating transaction events, the method comprising:
receiving transaction events identifying actions executed at a plurality of different types of source systems;
for each transaction event, determining by a processor whether or not the transaction event is equivalent to a previous transaction event using an equivalence relationship, wherein the equivalence relationship defines events as being equivalent when each of the events has a subset of parameters that match exactly and a different subset of parameters that match approximately and not exactly; and
correlating equivalent transaction events.

2. The method of claim 1 comprising:
grouping correlated transaction events into a transaction; and
detecting if fraud has taken place by analyzing a pattern of the correlated transaction events over a lifecycle of the transaction.

3. The method of claim 1 comprising generating correlated data summarizing the correlation between the transaction events.

4. The method of claim 1, wherein the equivalence relationship includes an identity value function that defines events to be equivalent if their function values are exactly or approximately equal.

5. The method of claim 1, wherein the equivalence relationship includes an identity equality function that defines events to be equivalent if their compared function value is within a predetermined range.

6. The method of claim 1, wherein the equivalence relationship is defined by a correlation configuration set associated with the type of the source system at which each transaction event action is executed, wherein each of a plurality of correlation configuration sets is associated with a different type of source system.

7. The method of claim 1 comprising representing transaction events using associated identity keys stored in a map data structure.

8. The method of claim 1, wherein the equivalence relationship defines an equivalence between repeated transaction events.

9. The method of claim 1, wherein the equivalence relationship defines an equivalence between an initial transaction event and an update thereof.

10. The method of claim 1, wherein the transaction events are correlated in real-time.

11. A system for correlating transaction events, the system comprising:
one or more processors configured to provide a correlation engine to receive transaction events identifying actions executed at a plurality of different types of source systems, wherein for each transaction event the correlation engine determines whether or not the transaction event is equivalent to a previous transaction event using an equivalence relationship, wherein the equivalence relationship defines events as being equivalent when each of the events has a subset of parameters that match exactly and a different subset of parameters that match approximately and not exactly; and
a memory to store correlation data defining correlations between transaction events that are determined by the correlation engine to be equivalent.

12. The system of claim 11 comprising a fraud detector, wherein the correlation engine groups correlated transaction events into a transaction and the fraud detector detects if fraud has taken place by analyzing a pattern of the correlated transaction events over a lifecycle of the transaction.

13. The system of claim 11, wherein the correlation engine generates data summarizing the correlation between the transaction events.

14. The system of claim 11, wherein the equivalence relationship includes an identity value function that defines events to be equivalent if their function values are exactly or approximately equal.

15. The system of claim 11, wherein the equivalence relationship includes an identity equality function that defines events to be equivalent if their compared function value is within a predetermined range.

16. The system of claim 11, wherein the equivalence relationship is defined by a correlation configuration set associated with the type of the source system at which each transaction event action is executed, wherein each of a plurality of correlation configuration sets is associated with a different type of source system.

17. The system of claim 11, wherein the correlation engine represents transaction events using associated identity keys stored in a map data structure.

18. The system of claim 11, wherein the equivalence relationship defines an equivalence between repeated transaction events.

19. The system of claim 11, wherein the equivalence relationship defines an equivalence between an initial transaction event and an update thereof

20. The system of claim 11, wherein the correlation engine correlates the transaction events in real-time.

21. A method of correlating transaction events and detecting fraud implemented using one or more processors and associated memories, the method comprising:
receiving incoming transaction events identifying actions executed at a plurality of different types of source systems;
assigning using a processor each incoming transaction event to a correlation configuration set;
executing from said correlation configuration set, using the processor, an equivalence relation identity value function;
determining, using the processor, for each incoming transaction event a corresponding identity key by using said equivalence relation identity value function;
using the processor, using an equivalence relation to determine, for a set of events having matching identity keys, which events are correlated, wherein the equivalence relation defines events as being equivalent using exact criteria on a subset of event parameters and fuzzy criteria on a different subset of event parameters;
using the processor, using the results of the correlation to trigger a flag or alert when possibly fraudulent data is detected.

22. A system for correlating transaction events, the system comprising:
one or more processors and associated memories configured to provide a correlation engine configured to:
receive incoming transaction events identifying actions executed at a plurality of different types of source systems;
assign each incoming transaction event to a correlation configuration set;
execute from said correlation configuration set an equivalence relation identity value function;
determine for each incoming transaction event a corresponding identity key by using said equivalence relation identity value function;
for the group of events that have matching identity keys, use an equivalence relation to determine which events are correlated, wherein the equivalence relation defines events as being equivalent using exact criteria on a subset of event parameters and fuzzy criteria on a different subset of event parameters;
use the results of the correlation to trigger a flag or alert when possibly fraudulent data is detected.
